(19) United States
(12) Patent Application Publication
(10) Pub. No.: US 2006/0028526 A1
(43) Pub. Date: Feb. 9, 2006

(54) Conveyance belt and belt conveyance device

(75) Inventor: Atsuhisa Nakashima, Nagoya-shi (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: BROTHER KOGYO KABUSHIKI KAISHA, Nagoya-shi (JP)

(21) Appl. No.: 11/196,686

(22) Filed: Aug. 4, 2005

(30) Foreign Application Priority Data
Aug. 9, 2004 (JP) 2004-231879

(51) Int. Cl. B41J 2/01

(52) U.S. Cl. 347/104; 347/103

(57) ABSTRACT

A conveyance belt includes a base member and an elastic member. The base member includes at least one member. The base member has an annular shape. The elastic member is fixed to an outer circumferential surface of the base member by an adhesive agent. The base member defines a plurality of holes passing through the base member in a thickness direction of the base member. The elastic member is exposed through the holes. The elastic member is lower in an elastic modulus than the base member.

### BACKGROUND OF THE INVENTION

1. Field of the Invention

The invention relates to a conveyance belt for conveying a sheet-like medium, and a belt conveyance device.

2. Description of the Related Art

A belt conveyance device in which a sheet-like recording medium is conveyed by an endless conveyance belt is used in a recording apparatus such as an ink jet printer, a label printer, and so forth. Generally, the conveyance belt has a double-layered or a multi-layered structure so that expansion or contraction does not occur in the conveyance belt. In a double-layered conveyance belt, a flat base member made of polyimide, urethane, etc. and an elastic member having adhesiveness such as silicone rubber are bonded to each other by an adhesive agent. In this bonding process, atmospheric air between the base member and the elastic member remains there as air bubbles, whereby concavities and convexities are formed on the surface of the conveyance belt. The air bubbles are removed in a process for securing close adhesion between the members. However, since the air bubbles can be discharged to the outside only through both widthwise ends of the conveyance belt, as the case may be, some of the air bubbles may still remain between the members at a central region of the conveyance belt. Further, since the adhesive agent contains a volatile ingredient, the volatile ingredient which is vaporized after the bonding process for bonding the base member and the elastic member to each other is implemented, is likely to be captured between the base member and the elastic member, whereby concavities and convexities may be formed on the surface of the conveyance belt.

If concavities and convexities are formed on the surface of the conveyance belt, specifically, when assuming that the conveyance surface of the belt and a recording section are separated by a predetermined distance as in the case of a recording head of an ink jet printer, the distance between the recording section and the conveyance surface of the belt varies from place to place on the conveyance surface of the belt. As a result, recording quality deteriorates. Moreover, at a place where the degree of convexity is significant, a recording medium cannot but be conveyed in a state in which it comes in contact with the recording head.

In addition, the conveyance belt is wound on rollers made of a metal and extends between the rollers. A frictional coefficient of the flat base member, which forms the inner surface of the conveyance belt and is made of polyimide or urethane, is small with respect to the metallic rollers. For this reason, since the base member may slip on the rollers while conveying the recording medium, the recording medium may be stopped for a moment. Therefore, recording quality deteriorates.

A flex-resistant conveyance belt is disclosed in JP 2000-168930 A. The flex-resistant conveyance belt includes a core member and a surface coating layer. The core member includes an endless knitted product, which is repeatedly formed of reinforcing line threads knitted through several courses, and a strengthening line thread knitted once so as to be inserted into the reinforcing line threads. The surface coating layer includes a rubber-like elastic member, which is bonded to the surface of the core member by an adhesive agent. In the conveyance belt disclosed in JP 2000-168930 A, since the core member includes the knitted product, the volatile ingredient, which is contained in the adhesive agent, can be easily discharged out of the inner surface of the conveyance belt through the core member. Therefore, concavities and convexities are scarcely formed on the outer surface of the conveyance belt. In addition, since the core member including the knitted product has a high frictional coefficient with respect to metallic rollers on which the conveyance belt is wound, slip of the conveyance belt on the rollers does not occur while the conveyance belt rotates.

### SUMMARY OF THE INVENTION

However, a driving force from the rollers on which the conveyance belt is wound is applied to the conveyance belt for a long time. Therefore, in the conveyance belt disclosed in JP 2000-168930 A, the conveyance belt is damaged at the edge surface of the core member. Specifically unknitting of the line threads occurs. Such unknitting of the line threads decreases the strength of the conveyance belt. Also, as the unknitted line threads come in contact with a sheet-like medium, which is laid, on the conveyance belt, a printing operation cannot be properly performed.

Accordingly, the invention provides an alternative kind of conveyance belt, which prevents unacceptably large concavities and convexities from being formed on the outer surface thereof. The invention also provides a belt conveyance device using the conveyance belt.

According to one aspect of the invention, a conveyance belt includes a base member and an elastic member. The base member includes at least one member. The base member has an annular shape. The elastic member is fixed to an outer circumferential surface of the base member by an adhesive agent. The base member defines a plurality of holes passing through the base member in a thickness direction of the base member. The elastic member is exposed through the holes. The elastic member is lower in an elastic modulus than the base member.

According to this structure, air bubbles captured between the base member and the elastic member can be discharged to outside of an inner surface of the conveyance belt through the holes defined in the base member. Accordingly, concavities and convexities are scarcely formed on the outer surface of the conveyance belt.

According to another aspect of the invention, a belt conveyance device includes a pair of rollers and an endless conveyance belt. The pair of rollers have respective rotation axes parallel to each other. The endless conveyance belt is wound on the rollers. The conveyance belt conveys a medium in a conveying direction in response to rotation of the rollers. The conveyance belt includes a base member and an elastic member. The base member includes at least one member. The base member has an annular shape. The elastic member is fixed to an outer circumferential surface of the base member by an adhesive agent. The base member defines a plurality of holes passing through the base member in a thickness direction of the base member. The elastic member is exposed through the holes. The elastic member is lower in an elastic modulus than the base member.

According to this structure, air bubbles captured between the base member and the elastic member can be discharged to outside of an inner surface of the conveyance belt through the holes defined in the base member. Accordingly, concavities and convexities are scarcely formed on the outer surface of the conveyance belt.

### BRIEF DESCRIPTION OF THE DRAWINGS

FIG. 1 is a view schematically illustrating an ink jet printer including a conveyance belt according to a first embodiment of the invention.

FIG. 2 is a perspective view illustrating a conveyance unit (a belt conveyance device) included in the ink jet printer shown in FIG. 1.

FIG. 3 is a section view taken along the line III-III of FIG. 2.

FIG. 4 is a plan view partially illustrating a base sheet forming the conveyance belt according to the first embodiment of the invention.

FIG. 5 is an enlarged view showing the part ‘V’ shown in FIG. 2.

FIG. 6 is an enlarged view showing the part ‘VI’ shown in FIG. 5.

FIG. 7 is a plan view partially illustrating a base sheet forms a conveyance belt according to a second embodiment of the invention.

### DETAILED DESCRIPTION OF THE EMBODIMENTS

Hereafter, preferred embodiments of the invention will be described with reference to accompanying drawings.

### First Embodiment

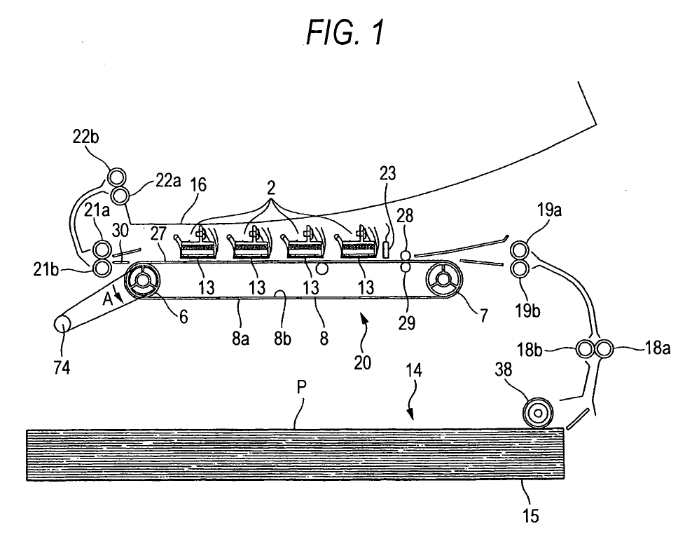

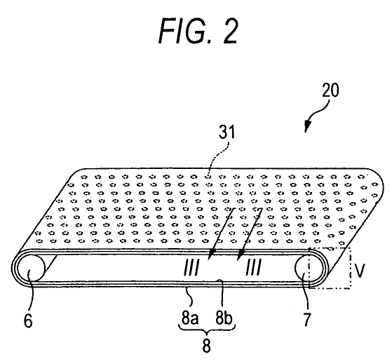

First, a first embodiment of the invention will be described with reference to FIGS. 1 and 2. FIG. 1 is a schematic view illustrating the entire structure of an ink jet printer according to this embodiment. FIG. 2 is a perspective view illustrating a conveyance unit.

An ink jet printer shown in FIG. 1 has an S-shaped paper path. In the course of the S-shaped paper path, a paper is fed from a paper accommodation section 15 of a paper-feeding device 14 by a paper-feeding roller 38. Then, the paper is reversed and guided onto a conveyance surface 27 facing four line-type recording heads 2. After that, the paper is reversed again and guided onto a discharge tray 16.

Specifically, the sheet-like cut papers P accommodated in the paper accommodation section 15 are fed one-by-one by the paper-feeding roller 38. Each cut paper P fed by the paper feeding roller 38 is reversed on a first curved path portion on which two pairs of conveyance rollers 18a, 18b and 19a, 19b are located, and then, is guided to a conveyance unit 20.

In the conveyance unit 20, a conveyance belt 8 is wound on belt rollers 6 and 7, which are disposed at a driving shaft and a driven shaft, respectively. The upper surface of the conveyance belt 8 serves as the conveyance surface 27. The belt rollers 6 and 7 are in contact with the inner surface 8b of the conveyance belt 8. By driving a conveyance motor 74 connected to the driving shaft of the belt roller 6 so that the belt roller 6 is rotated in the direction of an arrow A, the cut paper P adhered to the surface of the conveyance belt 8 is conveyed. The outer surface 8a of the conveyance belt 8 is processed with silicone rubber. Accordingly, the conveyance belt 8 holds the cut paper P on the outer surface 8a thereof with its adhesiveness.

The four recording heads 2 eject cyan (c), magenta (M), yellow (Y) and black (K) ink, respectively. The four recording heads 2 are arranged side by side in the conveying direction, while defining a slight gap between the lower surface of each recording head body 13 and the conveyance surface 27 of the conveyance belt 8. The respective inks ejected from the four recording heads 2 are superposed on each other on the cut paper P, thereby to form a color image on the cut paper P.

The cut paper P on which recording has been made is separated from the conveyance surface 27 by a separation plate 30. Then, after being reversed again on a second curved path portion including conveyance rollers 21a and 21b, the cut paper P is discharged by discharge rollers 22a and 22b onto the discharge tray 16 with the recorded surface of the cut paper P facing downward.

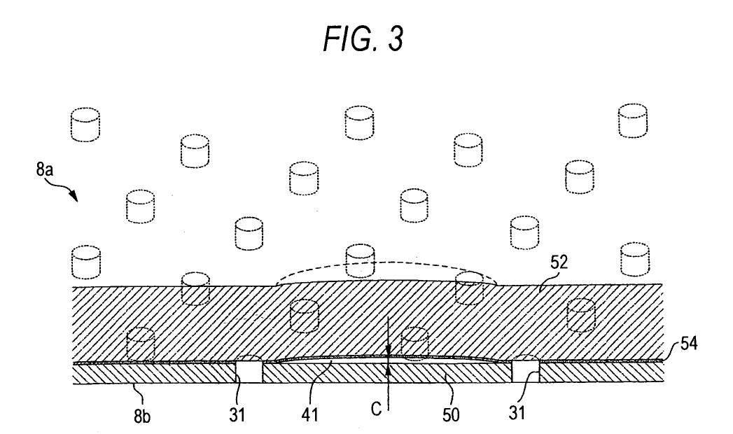

Next, details of the conveyance belt 8 will be described with reference to FIG. 3. FIG. 3 is a section view taken along the line III-III of FIG. 2. As shown in FIG. 3, an elastic sheet 52 is bonded to the entire outer surface of a base sheet 50. That is, as shown n FIG. 3, the conveyance belt 8 has a three-layered structure, which is composed of the endless base sheet 50 forming the inner surface of the conveyance belt 8, the elastic sheet 52 forming the outer surface 8a of the conveyance belt 8, and an adhesive layer 54 bonding the two sheets 50 and 52 to each other. The elastic sheet 52 is lower in an elastic modulus than the base sheet 50.

The base sheet 50 is made out of a flat sheet-like film member, which is made of polyimide, urethane, etc. and has a thickness of 0.1 to 0.2 mm. Since the base sheet 50 has an annular shape, the base sheet 50 is of the endless type. The base sheet 50 defines a plurality of holes 31, which pass through the base sheet 50 in a thickness direction of the base sheet 50. Each of the holes 31 has a cylindrical shape, which has an axis extending in the thickness direction of the base sheet 50. Each hole 31 has a diameter of 3 mm. Not the adhesive layer 54 but the elastic sheet 52 is exposed from the bottom of each of the holes 31. This is because the elastic sheet 54 is bonded to the base sheet 50 after an adhesive agent is applied to the base sheet 50. In the present embodiment, the adhesive agent of the adhesive layer 54 is not introduced into the holes 31 of the base sheet 50. It is noted that even if a small amount of the adhesive agent remains at an edge of a hole 30, there arises no problem in this embodiment.

The plurality of holes 31 are regularly arranged in a zigzag pattern such that a distance between centers of two adjacent holes 31 is 17 mm and a distance between outer circumferences of the two adjacent holes 31 is 14 mm. The term “distance between the outer circumferences of the two adjacent holes” means the minimum distance between the outer circumferences of the two adjacent holes. In the present embodiment, the centers of three adjacent holes 31 are positioned at vertexes of a regular triangle, respectively. In other words, the distance between the centers of two adjacent holes 31 is constant. The plurality of holes 31 constitutes a plurality of hole rows, which extends in the circumferential direction of the base sheet 50. A ratio of a total opened area of the holes 31 to the entire surface area of the base sheet 50 is about 2%.

The elastic sheet 52 bonded to the outer surface of the base sheet 50 is made of silicone rubber having a low grade of hardness. The elastic sheet 52 has a thickness of 1 to 2 mm. A material of the elastic sheet 52 may be an elastic material such as EPDM (ethylene propylen diene monomer), urethane rubber, (for example, millable polyurethane) butyl rubber, and the like. In order to cohesively hold the cut paper P on the conveyance belt 8, the elastic sheet 52 has an Asker C hardness of 10 degrees or less. Preferably, the elastic sheet 52 has an Asker C hardness of 5 degrees or less, and in particular, it is preferred that the elastic sheet 52 has an Asker C hardness of 1 to 2 degrees. The elastic sheet 52 covers the outer surface of the base sheet 50, which defines the plurality of holes 31. Since the base sheet 50 is relatively thin and the holes 31 straightly pass through the base sheet 50, in the conveyance belt 8 according to the present embodiment, the elastic sheet 52 enters into the holes 31, which exist in a region where the belt rollers 7 and 8 exist. As a result, the inner surface of the elastic sheet 52 entered into the holes 31 partially forms the inner surface 8b of the conveyance belt 8, as will be described in detail below.

The adhesive layer 54 has a thickness of about 0.07 mm. The adhesive agent used in the adhesive layer 54 may be: an aqueous adhesive, which is prepared by dispersing polyvinyl acetate resin or acryl resin in water in the form of a colloid; an organic solvent-based adhesive, which is prepared by dissolving synthetic resin or synthetic rubber in an organic solvent; a non-solvent type elastic adhesive, which is cured by chemically reacting with moisture contained in the air; and a two-part adhesive, which is used by mixing a main ingredient and a curing agent. All of these adhesives have some volatile ingredients. Specifically, moisture in the aqueous adhesive, the organic solvent such as xylene or toluene in the organic solvent-based adhesive, and adhesive ingredients in the elastic adhesive and the two-part adhesive are the volatile ingredients.

These volatile ingredients are volatilized even after the base sheet 50 and the elastic sheet 52 are bonded to each other. As a vaporized volatile ingredient accumulates between the base sheet 50 and the elastic sheet 52, an air bubble 41 is produced. If the air bubble 41 is produced, since the elastic sheet 52 rises by a height corresponding to the thickness ‘n’ of the air bubble 41, flatness of the conveyance belt 8 deteriorates. Also, in addition to the air bubbles 41, which are produced in the conveyance belt 8 due to the volatile ingredient contained in the adhesive agent, other air bubbles 41 may be produced due to atmospheric air which is captured between the base sheet 50 and the elastic sheet 52 when bonding them to each other and is not removed by a subsequent air bubble removing process.

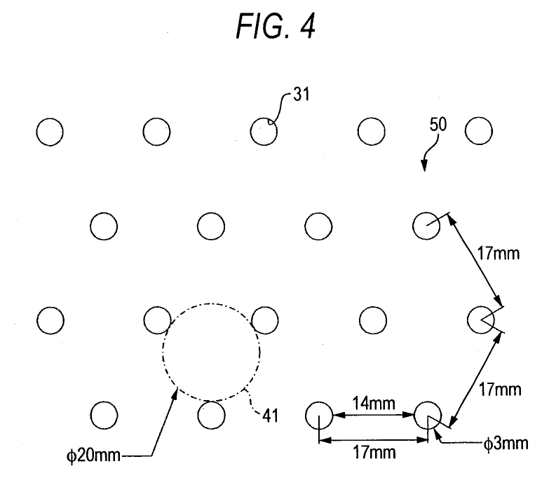

FIG. 4 is a partial plan view illustrating the base sheet 50. The air bubble 41, which contains the vapor generated due to the presence of the volatile ingredient of the adhesive agent, gradually grows in volume with the lapse of time until the vaporization of the volatile ingredient is completed. In the present embodiment, if the air bubble 41 grows up to a diameter of about 20 mm, the air bubble 41 communicate with any one of the holes 31, which are located around the corresponding air bubble 41. Namely, since the centers of three adjacent holes 31 are positioned at vertexes of a regular triangle, respectively, a diameter of the largest circle, which is tangent to the three adjacent holes 31 and is located among the three adjacent holes 31 (that is, has a maximum size as a circle being not in contact with the holes 31) can be expressed by:

$$2 \times ( \frac{a}{\sqrt{3}} - \frac{b}{2} )$$

where ‘a’ denotes a distance between centers of two adjacent holes 31 and ‘b’ denotes a diameter of the hole 31. Here, the diameter of 20 mm is obtained by substituting 17 mm for ‘a’ and 3 mm for ‘b’ in the expression. If the air bubble 41 communicates with the hole 31 as described above, the vapor in the air bubble 41 is discharged to the outside through the corresponding hole 31. That is, it should be noted that an air bubble 41 having a diameter of 20 mm or more cannot exist in the conveyance belt 8. Consequently, it is possible to prevent the diameter of the air bubble 41 containing the vapor generated due to the volatile ingredient of the adhesive agent, from excessively increasing between the base sheet 50 and the elastic sheet 52. As a result, the thickness ‘n’ of the air bubble 41 can be decreased.

Specifically, since a rising angle of the elastic sheet 52 with respect to the base sheet 50 is about 10 when assuming that the maximum diameter of the air bubble 41 is 20 mm, the thickness ‘n’ of the air bubble 41 can be made about 0.2 mm. When the plurality of holes 31 having a diameter of 3 mm are arranged such that the distance between the centers of two adjacent holes 31 is 17 mm, a ratio of the total opened area of the holes 31 of the base sheet 50 to the entire surface area of the base sheet 50 is equal to 2%. In other words, when the plurality of holes 31 are regularly arranged such that the distance between the centers of two adjacent holes 31 is equal to that between the centers of two other adjacent holes 31, it is possible to suppress the thickness ‘n’ of the air bubble 41 below 0.2 mm by setting the ratio of the total opened area of the holes 31 to the entire surface area of the base sheet 50 to be 2% or more.

In the meanwhile, if the opening ratio of the holes 31 to the entire surface area of the base sheet 50 is excessively large, it is difficult to obtain strength, which is required for the conveyance belt 8. As the opening ratio increases, the strength of the conveyance belt 8 decreases. Therefore, it is preferred that the opening ratio be 50% or less in order to properly maintain the strength of the conveyance belt 8. When assuming that the diameter of the hole 31 is 3 mm and the opening ratio is 50%, the distance between the centers of two adjacent holes 31 becomes 3.7 mm. More preferably, the opening ratio is in the range of 10 to 40%, and further preferably, the opening ratio is in the range of 15 to 35%. Preferably, the distance between the centers of two adjacent holes 31 is in the range of 10 to 17 mm, and more preferably, the distance between the centers of two adjacent holes 31 is in the range of 13 to 16 mm. Further preferably, the distance between the centers of two adjacent holes 31 is 15 mm.

Here, a method of manufacturing the conveyance belt 8 according to this embodiment of the invention will be described in sequence of process.

(1) A sheet-like film is manufactured using a material having low strechability such as polyimide and PET (polyethylene terephthalate).

(2) The holes 31 are formed in the sheet-like film by pressing.

(3) Both lengthwise ends of the sheet-like film are joined to each other by applying heat and pressure. At this time, the joined portion is made to have the same thickness as other portions of the sheet-like film. In this way, a seamless belt (the base sheet 50) is formed.

(4) After placing a mold on the inner surface of the seamless belt, an adhesive agent is thinly applied to the outer surface of the seamless belt.

(5) A rubber tube, which is formed by extruding silicone rubber or millable polyurethane and has a thickness in the range of 1.0 to 2.0 mm, is attached on the outer surface of the seamless belt by an adhesive agent.

(6) A process of planarization by roller-pressing, an air removing process, a process of securing close adhesion, and so forth, are performed. In the process (1), if the seamless sheet-like film may be directly manufactured, the process (3) can be omitted. In order to manufacture the seamless sheet-like film, a coating layer is first formed by uniformly applying liquid resin on the surface of a core element, and then, the coating layer is heated to cure the resin with the coating layer held on the core element. After that, the cured resin is separated from the core element.

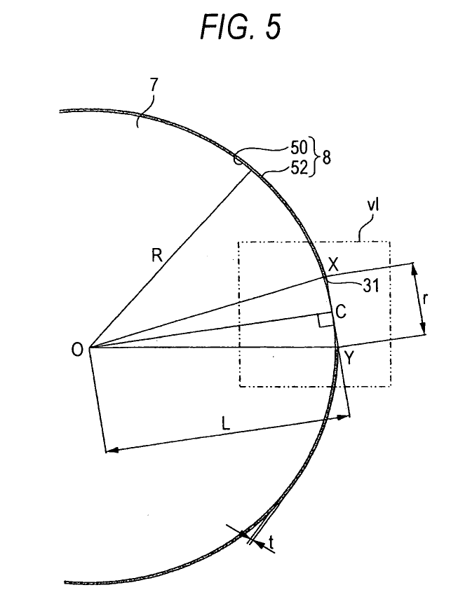

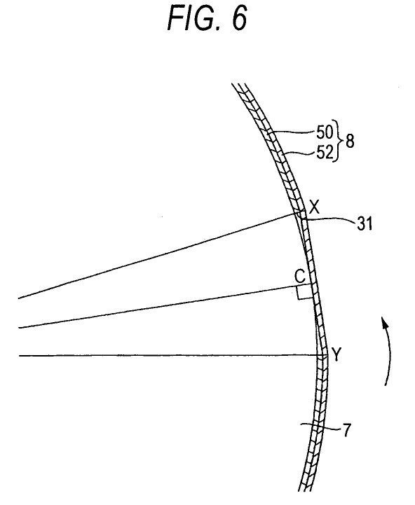

Hereafter, the relationship between the belt roller 7 and the conveyance belt 8 will be further described with reference to FIGS. 5 and 6. FIG. 5 is an enlarged section view showing the part ‘V’ shown in FIG. 2, and FIG. 6 is an enlarged view showing the part ‘VI’ shown in FIG. 5. The elastic sheet 52 is shown by a line in FIG. 5, and the adhesive layer 54 is omitted in FIGS. 5 and 6. Further, since the relationship between the belt roller 7 and the conveyance belt 8 to be described below is the same as that between the belt roller 6 and the conveyance belt 8, the latter will not be separately explained herein.

As shown in FIG. 5, a distance L between a center 0 of the belt roller 7 and a middle point C of the line segment connecting two points X and Y, which are located on the outer surface of the elastic sheet 52 and correspond to both diametric ends of the hole 31, is expressed as:

$${\{ {( R + t )}^{2} - {( \frac{r}{2} )}^{2} \}}^{\frac{1}{2}}$$

from Pythagoras's theorem, where R denotes the radius of the belt roller 7, r denotes the diameter of the hole 31 and t denotes the thickness of the base sheet 50. In the present embodiment, the radius R of the belt roller 7, the diameter r of the hole 31 and the thickness t of the base sheet 50 are determined such that the inequality, L<R, that is, is satisfied.

Therefore, as shown in FIG. 6,

$${\{ {( R + t )}^{2} - {( \frac{r}{2} )}^{2} \}}^{\frac{1}{2}} < R$$

the elastic sheet 52 comes in contact with the belt roller 7 at least in the vicinity of the middle point C. That is, in the conveyance belt 8, as the elastic sheet 52 enters into the holes 31, which exist in a region where the belt rollers 7 and 8 exist, the inner surface of the elastic sheet 52 partially forms the inner surface 8b of the conveyance belt 8 in the corresponding holes 31. Consequently, when compared to the case in which the elastic sheet 52 does not come in contact with the belt roller 7 through the corresponding holes 31, the gripping force of the conveyance belt 8 for gripping the belt roller 7 increases because of the lower elastic modulus of the elastic sheet 52. As a result, the conveyance belt 8 hardly slips on the belt roller 7.

In particular, in the present embodiment, the static frictional coefficient between the elastic sheet 52 and the belt roller 7 is greater than that between the base sheet 50 and the belt roller 7. For this reason, as the elastic sheet 52 comes in contact with the belt roller 7 through the corresponding holes 31, the gripping force of the conveyance belt 8 for gripping the belt roller 7 is significantly increased, whereby slippage of the conveyance belt 8 on the belt roller 7 further hardly occurs.

In the present embodiment, in order to increase a contact area between the elastic sheet 52 and the belt rollers 6 and 7, it is preferred that a thickness of the base sheet 50 be made as thin as possible within the range capable of securing a sufficient mechanical strength.

Furthermore, since the plurality of holes 31 are regularly arranged in the zigzag pattern, the gripping force applied from the belt roller 7 uniformly act on the elastic sheet 52. Accordingly, the conveyance belt 8 still further hardly slips on the belt roller 7.

As described above, in the conveyance belt 8 according to the present embodiment of the invention, since the base sheet 50 is made out of a single flat sheet-like film member, even when a driving force from the belt rollers 6 and 7 is applied to the conveyance belt 8 for a long time, differently from the conveyance belt disclosed in JP 2000-168930 A, unknitting does not occur at the edge surfaces of the base sheet 50. Thus, it is possible to avoid a disadvantage such as a printing failure caused by unknitting of line threads, and to prevent belt strength from decreasing. Furthermore, differently from the conveyance belt disclosed in JP 2000-168930 A, this embodiment can achieve such an advantage that the base sheet 50 is hardly deformed.

In addition, since the elastic sheet 52 is exposed to the outside through each of the holes 31, no opening is provided on the outer surface 8a of the conveyance belt 8. Therefore, fine dust generated from the cut paper C is substantially prevented from entering the holes 31, whereby a cycle for performing the operation of removing the dust from the holes 31 can considerably increase in length.

Also, the holes 31 are regularly defined in the base sheet 50. Therefore, it is easy to design positions where the plurality of holes 31 are defined. Also, the holes are arranged so that a distance between centers of two adjacent holes is equal to that between centers of two other adjacent holes. Since the plurality of holes 31 are substantially uniformly distributed on the base sheet 50, it is easier to suppress accumulation of a vaporized volatile ingredient of the adhesive agent. In addition, the holes 31 are arranged to form a plurality of rows, which extend in a circumferential direction of the base member. Since the plurality of holes 31 are uniformly distributed on the base sheet 50 in a circumferential direction thereof, it is still easier to suppress accumulation of the vaporized volatile ingredient of the adhesive.

Moreover, since the holes 31 are opened on the inner surface 8b of the conveyance belt 8, if the air bubble 41 produced by the volatile ingredient of the adhesive increases in volume to communicate with any hole 31, the vapor (the volatile ingredient) contained in the air bubble 41 is discharged to the outside through the corresponding hole 31 to the outside of the inner surface 8b of the conveyance belt 8. Accordingly, a significantly large air bubble 41 cannot be produced. Also, since the atmospheric air captured between the base sheet 50 and the elastic sheet 52 when bonding the base sheet 50 and the elastic sheet 52 to each other is discharged to the outside through the hole 31, the air bubble 41 produced due to the presence of the atmospheric air is prevented from significantly increasing in size. As a consequence, concavities and convexities generating significantly large differences in height are not formed on the outer surface 8a of the conveyance belt 8. As a result, since it is possible to maintain a desired flatness on the outer surface 8a, which serves as the conveyance surface 27 of the conveyance belt 8, high printing quality is ensured.

Furthermore, since the static frictional coefficient between the elastic sheet 52 and the belt roller 7 is sufficiently greater than that between the base sheet 50 and the belt roller 7 and part of the elastic sheet 52, which enters into the holes 31 located on the belt rollers 6 and 7, comes in contact with the belt rollers 6 and 7, the gripping force of the conveyance belt 8 for gripping the belt rollers 6 and 7 is increased. As a result, the conveyance belt 8 hardly slips on the belt rollers 6 and 7. For this reason, additional high printing quality is also ensured.

### Second Embodiment

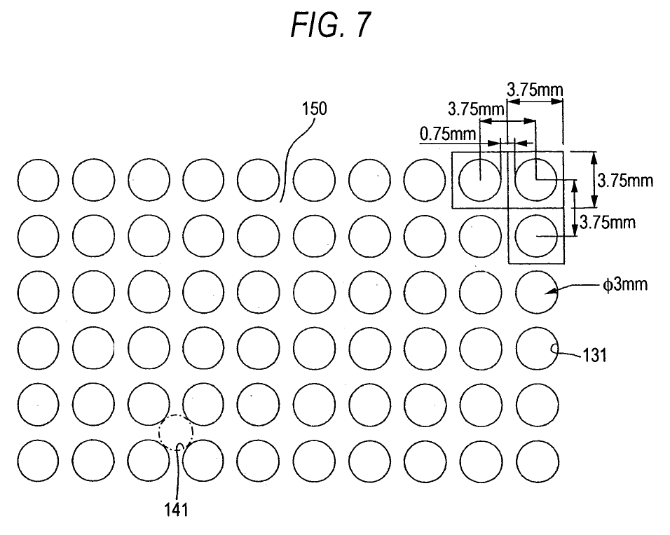

Next, a structure of a conveyance belt according to a second embodiment of the invention will be described with reference to FIG. 7, which is a partial plan view showing a base sheet. The same reference numerals will be given to the same or like parts as those of the first embodiment, and detailed description thereof will be omitted herein. The structure of the second embodiment is mainly different from that of the first embodiment in an arrangement of holes defined in a base sheet and a diameter of the holes.

As shown in FIG. 7, the base sheet 150 formed of a flat member defines a plurality of holes 131, which passes through the base sheet 150 in a thickness direction of the base sheet 150. Similarly to the first embodiment, an elastic sheet (not shown) is exposed to the outside through the holes 131.

Each of the holes 131 has a cylindrical shape, which has an axis extending in the thickness direction of the base sheet 150 and has a diameter of 3 mm. The plurality of holes 131 are arranged in a square lattice-shape. That is, the plurality of holes 131 form a plurality of hole rows which extends in a circumferential direction of the base sheet 150. A straight line connecting centers of two adjacent holes, which belong to two adjacent hole rows, respectively, is parallel to a direction perpendicular to the circumferential direction of the base member 150, on the inner surface of the base sheet 150. The plurality of holes 131 is regularly spaced apart from one another both in the circumferential direction of the base sheet 150 and in the direction perpendicular to the circumferential direction. In the present embodiment, the centers of four adjacent holes 131 are positioned at vertexes of a square, respectively. The distance between the centers of two adjacent holes 131 is 3.75 mm. The distance between the facing outer circumferences of two adjacent holes 131 is 0.75 mm. The ratio of the total opened area of the plurality of holes 131 to the entire surface area of the base sheet 150 is 50%. This ratio is a maximum value for maintaining a minimum strength of the base sheet 150.

As shown in FIG. 7, in the conveyance belt according to this embodiment, an air bubble 141 cannot grow in its diameter above about 2.3 mm. Moreover, it is possible to suppress the thickness ‘n’ of the air bubble 141 compared to the first embodiment. Further, even in this embodiment, the advantages achieved by the first embodiment can be similarly achieved.

Although the preferred embodiments of the invention have been described, the invention is not limited thereto, and various modifications, additions and substitutions are possible, without departing from the scope and spirit of the invention as disclosed in the accompanying claims. For example, although the base sheet is formed of one flat member in the above embodiments, the base sheet may be formed by weaving several flat members together. In this case, it is also possible to avoid unknitting of the base sheet.

Also, an arrangement of the holes, which are defined in the base sheet, is not limited to those described in the above embodiments. For example, the plurality of holes may be irregularly arranged in the base sheet. Further, the holes defined in the base sheet may not have a cylindrical shape. For example, the holes defined in the base sheet may have an elliptical or rectangular sectional shape. When each hole has an elliptical sectional shape, it is preferred that the minor axis of the elliptical sectional shape corresponds to a belt installation direction. If a hole has an elliptical sectional shape or a rectangle sectional shape other than a circular sectional shape, the “center” of the hole means a center of gravity of the sectional shape of the hole. It is also possible to properly adjust the distance between outer circumferences of two adjacent holes, the distance between centers of two adjacent holes, the diameter of the holes, the ratio of the total opened area of the plurality of the holes in the base sheet.

Furthermore, when some holes are located on the belt rollers in response to rotation of the belt rollers, the elastic sheet may not come in contact with the belt rollers through the corresponding holes. Even in the case that the elastic sheet comes in contact with the belt rollers, the static frictional coefficient between the elastic sheet and the belt roller may be less than that between the base sheet and the belt roller. Moreover, the above-described inequality of:

$${\{ {( R + t )}^{2} - {( \frac{r}{2} )}^{2} \}}^{\frac{1}{2}} < R$$

is established only when the hole has a circular section shape and the belt roller has a cylindrical shape. If the hole does not have a circular sectional shape or the belt roller does not have a cylindrical shape, even when the above inequality is not established the elastic sheet may come in contact with the belt rollers through the holes.

Furthermore, although the elastic sheet having adhesiveness is used in the above embodiments, the elastic sheet may have no adhesiveness.

Not only the cut paper but also a continuously extending medium such as a rolled paper may be used as the printing medium to be conveyed.

The conveyance belt according to the invention and the belt conveyance device using the same are not limited to just an ink jet printer. For example, the conveyance belt and the belt conveyance device according to the invention can be widely applied to a ticket conveyance device included in a ticket checker, a bill conveyance device included in a cash dispenser such as an automatic teller machine (ATM), an automatic document feeder, etc.

What is claimed is:

1. A conveyance belt comprising:
a base member that comprises at least one member, the base member having an annular shape; and
an elastic member fixed to an outer circumferential surface of the base member by an adhesive agent, wherein:
the base member defines a plurality of holes passing through the base member in a thickness direction of the base member;
the elastic member is exposed through the holes; and
the elastic member is lower in an elastic modulus than the base member.

2. The conveyance belt according to claim 1, wherein the holes are regularly defined in the base member.

3. The conveyance belt according to claim 2, wherein the holes are arranged so that a distance between centers of two adjacent holes is equal to that between centers of two other adjacent holes.

4. The conveyance belt according to claim 2, wherein the holes are arranged to form a plurality of rows, which extend in a circumferential direction of the base member.

5. The conveyance belt according to claim 4, wherein the holes are arranged in a zigzag pattern.

6. The conveyance belt according to claim 4, wherein a straight line connecting centers of two adjacent holes, which belong to two adjacent hole rows, respectively, is perpendicular to the circumferential direction of the base member.

7. The conveyance belt according to claim 3, wherein a distance between outer circumferences of two adjacent holes is equal to or smaller than 14 mm.

8. The conveyance belt according to claim 7, wherein a distance between centers of two adjacent holes is equal to or larger than 3.7 mm.

9. The conveyance belt according to claim 1, wherein a ratio of a total opened area of the holes to an entire surface area of the base member is in a range of 2% to 50%.

10. The conveyance belt according to claim 1, wherein the elastic member has adhesiveness.

11. The conveyance belt according to claim 10, wherein the elastic member is equal to or smaller than 10 in Asker C hardness.

12. The conveyance belt according to claim 1, wherein:
a diameter of a virtual circle, which is externally tangent to at least three adjacent holes, is equal to or smaller than 20 mm; and
the at least three adjacent holes are externally tangent to the virtual circle.

13. A belt conveyance device comprising:
a pair of rollers having respective rotation axes parallel to each other; and
an endless conveyance belt wound on the rollers, the conveyance belt that conveys a medium in a conveying direction in response to rotation of the rollers, wherein:
the conveyance belt comprises:
a base member that comprises at least one member, the base member having an annular shape; and
an elastic member fixed to an outer circumferential surface of the base member by an adhesive agent;
the base member defines a plurality of holes passing through the base member in a thickness direction of the base member;
the elastic member is exposed through the holes; and
the elastic member is lower in an elastic modulus than the base member.

14. The belt conveyance device according to claim 13, wherein when the holes are located on the roller in response to the rotation of the rollers, the elastic member comes in contact with the roller through the holes located on the roller.

15. The belt conveyance device according to claim 14, wherein:
an inequality of:
$${\{ {( R + t )}^{2} - {( \frac{r}{2} )}^{2} \}}^{\frac{1}{2}} < R$$
is established where R represents a radius of the roller, r represents a diameter of each hole and t represents a thickness of the base member.

16. The belt conveyance device according to claim 14, wherein a static frictional coefficient between the elastic member and each of the rollers is larger than that between the base member and each of the rollers.

17. The belt conveyance device according to claim 14, wherein the holes are regularly defined in the base member.

18. The belt conveyance device according to claim 17, wherein the holes are arranged so that a distance between centers of two adjacent holes is equal to that between centers of two other adjacent holes.

19. The belt conveyance device according to claim 17, wherein the holes are arranged to form a plurality of rows, which extend in a circumferential direction of the base member.

20. The belt conveyance device according to claim 19, wherein the holes are arranged in a zigzag pattern.

21. The belt conveyance device according to claim 19, wherein a straight line connecting centers of two adjacent holes, which belong to two adjacent hole rows, respectively, is perpendicular to the circumferential direction of the base member.

22. The belt conveyance device according to claim 19, wherein a distance between outer circumferences of two adjacent holes is equal to or smaller than 14 mm.

23. The belt conveyance device according to claim 22, wherein a distance between centers of two adjacent holes is equal to or larger than 3.7 mm.

24. The belt conveyance device according to claim 13, wherein a ratio of a total opened area of the holes to an entire surface area of the base member is in a range of 2% to 50%.

25. The belt conveyance device according to claim 13, wherein the elastic member has adhesiveness.

26. The belt conveyance device according to claim 25, wherein the elastic member is equal to or smaller than 10 in Asker C hardness.

27. The belt conveyance device according to claim 13, wherein:
a diameter of a virtual circle, which is externally tangent to at least three adjacent holes, is equal to or smaller than 20 mm; and
the at least three adjacent holes are externally tangent to the virtual circle.
